(19) United States
(12) Patent Application Publication
(10) Pub. No.: US 2025/0176577 A1
(43) Pub. Date: Jun. 5, 2025

(54) PLANT-ONLY DAIRY REPLACEMENT SYSTEM FOR FOODS

(71) Applicant: The Live Green Group, Inc., Middletown, DE (US)

(72) Inventors: Sasikanth Chemalamudi, San Fernando (CL); Priyanka Srinivas, San Fernando (CL)

(73) Assignee: The Live Green Group, Inc., Middletown, DE (US)

(21) Appl. No.: 18/840,950

(22) PCT Filed: Feb. 8, 2023
(86) PCT No.: PCT/IB2023/051114

§ 371 Date: Aug. 23, 2024

(30) Foreign Application Priority Data
Feb. 28, 2022 (US) 63314543

(51) Int. Cl. A23C 11/10; A23L 9/20; A23L 19/00

(52) U.S. Cl. CPC A23C 11/103; A23L 9/24; A23L 19/00

(57) ABSTRACT

The present disclosure discloses a plant-only composition for a food product and a method to prepare the plant-only composition for a food product. The plant-only composition comprises (i) about 5% to 40% weight by weight of a plant-derived cream; (ii) about 0.5% to 10% weight by weight of a plant seed mucilage; (iii) about 0.5% to 10% weight by weight of a fruit and/or vegetable mucilage; (iv) about 2% to 20% weight by weight of a plant-derived protein; (v) about 15% to 60% weight by weight of a plant-derived milk; (vi) about 0.1% to 10% weight by weight of a plant-derived lactone enhancer; (vii) about 0.1% to 10% weight by weight of a plant-derived flavor enhancer; and (viii) about 0.5% to 10% weight by weight of a plant derived nutrient enhancer. The plant-only composition substitutes a diary-based ingredient or an egg-based ingredient in the food product. The dairy based ingredient comprises any of milk, milk cream, butter, fermented milk product, yogurt, cheese, custard, frozen, or casein.

### CROSS-REFERENCE TO RELATED APPLICATIONS

This application which claims the benefit of U.S. Provisional Application No. 63/314,543, filed Feb. 28, 2022, titled “Plant only dairy replacement system for foods”. The entire contents of the above-identified applications are hereby fully incorporated herein by reference.

### BACKGROUND

### Technical Field

Embodiments of this disclosure relates to a plant-only composition, and more particularly, relates to a plant-only composition for a food product that replaces a conventional dairy (i.e., milk) and egg ingredient in the food product. The present disclosure also relates to a food product comprising a plant-only composition. The present disclosure also relates a dairy replacement composition for a food product and a process of preparing the plant-only composition.

### Description of the Related Art

Many conventional food products and, in particular, frozen dessert products (e.g., ice cream products), include some form of dairy ingredient derived from animals, such as milk and egg ingredients. For example, conventional ice creams include 10-16% milk fats. Higher milk fat ice creams generally provide a smooth texture because they include reduced water content and accordingly fewer ice crystals formed in the ice cream. Eggs are among many ingredients used in the formulation of conventional, dairy based products such as ice creams. For example, eggs can be added to conventional ice creams to achieve firmer ice cream at a given drawing temperature, increased whipping rate, less change in percent overrun while unloading the freezer, and improved appearance for ice cream while it is melting.

Dairy based ingredients can be hard on digestive systems for certain people, particularly those who may be lactose intolerant or suffer from other forms of ailments associated with such ingredients. In addition, people who maintain a plant-based diet struggle with finding products that simulate conventional ice cream or other dairy products but do not include dairy ingredients.

It would be desirable to provide a dairy replacement system to replace conventional egg and milk ingredients in products that consists of minimally processed, plant-only ingredients while ensuring desirable flavor, texture, appearance and taste as well as the same or similar functionality of conventional dairy ingredients for the food product to which the system is incorporated.

Thus, there is a need for a plant-only composition for a food product to substitute the conventional dairy ingredients for the food product.

### SUMMARY

In view of the foregoing, embodiments herein provide a plant-only composition for a food product. The plant-only composition comprises (i) about 5% to 40% weight by weight of a plant-derived cream; (ii) about 0.5% to 10% weight by weight of a plant seed mucilage; (iii) about 0.5% to 10% weight by weight of a fruit and/or vegetable mucilage; (iv) about 2% to 20% weight by weight of a plant-derived protein; (v) about 15% to 60% weight by weight of a plant-derived milk; (vi) about 0.1% to 10% weight by weight of a plant-derived lactone enhancer; (vii) about 0.1% to 10% weight by weight of a plant-derived flavor enhancer; and (viii) about 0.5% to 10% weight by weight of a plant-derived nutrient enhancer. The plant-only composition substitutes a diary ingredient in the food product.

In some embodiments, the plant-derived cream comprises at least one of coconut cream, rice cream, cashew cream, sesame seeds cream, cassava cream, oat milk cream, white bean cream, tofu cream, three leaf yam cream, sweet potato cream, sunflower seeds cream or a combination thereof. In some embodiments, the plant-derived cream present in the plant-only composition ranges from about 5% to 30% weight by weight of the composition. In some embodiments, the plant-derived cream comprises a lipid percentage of about 16% to 50%, a pH of about 3 to 6, and an emulsion stability of about 50% to 96%.

In some embodiments, the plant seed mucilage comprises at least one of flax seed mucilage, basil seed mucilage, chia seeds mucilage, psyllium seed mucilage, Balangu seed mucilage, quince seed mucilage, Arabidopsis seed coat mucilage, yellow mustard seed mucilage, sage seed mucilage, Ipomoea digitata seed mucilage, Eruca sativa seed mucilage or a combination thereof. In some embodiments, the plant seed mucilage present in the plant-only composition ranges from about 0.5% to 7% weight by weight of the composition.

In some embodiments, the flax seed mucilage comprises a soluble fiber in an amount ranging from about 7% to 10% of the flax seed mucilage, neutral and acidic monosaccharides in an amount ranging from about 80% of the flax seed mucilage and protein in an amount ranging from about 9% of the flax seed mucilage. In some embodiments, the plant seed mucilage comprises a viscosity of about 6000 to 7500 millipascal (mPas), a water holding capacity (WHC) of about 35 to 1024.66 gram by gram and a foaming capacity of more than 30%.

In some embodiments, the flax seed mucilage is synthesised by (i) stirring flax seeds for about 5 hours in distilled water at about 60° C. and at a mixing speed of about 300 revolution per minute (rpm) to obtain a flax seed solution, (ii) separating the mucilage from the flax seed solution by filtering through a 40-mesh screen, and (iii) precipitating the separated with 95% ethanol, followed by further separation by centrifuging at 3000 rpm for about 10 minutes.

In some embodiments, the fruit and/or vegetable mucilage comprises at least one of okra mucilage, mangosteen mucilage, moringa mucilage, assyrian plum mucilage, prickly pear mucilage, cassava mucilage, spinach leaves mucilage, Basella alba mucilage, Indian jujube fruit mucilage, coromandel ebony mucilage, orange fiber mucilage, tilkor fruit mucilage or a combination thereof. In some embodiments, the fruit and/or vegetable mucilage present in the plant-only composition ranges from about 0.5% to 7% weight by weight of the composition.

In some embodiments, the okra mucilage comprises (i) a polysaccharide rich material comprising galactose, rhamnose and galacturonic acid at concentrations between 20% and 30%, (ii) 11% of protein, (iii) 40% of carbohydrates, (iv) 10% of moisture, (v) 10% of ash, (vi) 0.5% of magnesium, (vii) about 3.0% of calcium, (viii) 0.1%-0.7% of potassium and (ix) 0.14%-0.18% of phosphorus. In some embodiments, the fruit and/or vegetable mucilage has an emulsion stability of about 42.22% to 70%, and an oil absorption capacity of more than 5%.

In some embodiments, the plant-derived protein comprises at least one of pea protein, soy protein, potato protein, chickpea protein, quinoa protein, black lentil protein, peanut protein, almond protein, chia seed protein, pinto bean protein, oat protein, melon seed protein or a combination thereof. In some embodiments, the plant-derived protein present in the plant-only composition ranges from about 3% to 18% weight by weight of the composition. In some embodiments, the plant-derived protein comprises a zeta potential of −20 to −40 millivolt (mV), a solubility index of about 16% to 20%, a molecular weight of about 10 to 50 kilodaltons (kDa), and an improved solubility in the pH ranges below 4 and above 5, which is outside their isoelectric pH usually between 4 to 5. In some embodiments, the pea protein comprises 7S and 11S globulin proteins and 2S albumin proteins that simulate dairy and egg protein.

In some embodiments, the plant-derived milk comprises at least one of hemp seed milk, oat milk, soy milk, potato milk, almond milk, sesame milk, macadamia milk, hazelnut milk, lupin milk, coconut milk, cowpea milk or a combination thereof. In some embodiments, the plant-derived milk present in the plant-only composition ranges from about 20% to 55% weight by weight of the composition. In some embodiments, the hemp seed milk comprises high quality protein source that includes all essential amino acids.

In some embodiments, the plant-derived lactone enhancer comprises at least one of peach, carrot, apricots, raspberries, strawberries, pineapple, plums, celery, coconut, orange, filberts, peanuts or a combination thereof. In some embodiments, the plant-derived lactone enhancer present in the plant-only composition ranges from about 0.3% to 7% weight by weight of the composition.

In some embodiments, the plant-derived flavor enhancer comprises at least one of kithul, raisins, durian, pears, prunes, monk fruit, sapodilla, agave, white peach, passion fruit, custard apple, banana or a combination thereof. In some embodiments, the plant-derived flavor enhancer present in the plant-only composition ranges from about 0.3% to 7% weight by weight of the composition.

In some embodiments, the plant-derived nutrient enhancer comprises at least one of blueberries, strawberries, raspberries, cranberries, bilberry, redcurrant, blackberries, grapefruit, lingonberry, elderberry or a combination thereof. In some embodiments, the plant-derived nutrient enhancer present in the plant-only composition ranges from about 1% to 7% weight by weight of the composition.

In some embodiments, the plant seed mucilage or the fruit and/or vegetable mucilage comprises pectin, and wherein the pectin forms a cross-linked gel in water in the presence of calcium ions, wherein the cross-linked gel network or polysaccharide entanglement mimics physical and sensory characteristics of emulsified fats that simulate milk/diary fats.

In some embodiments, the plant-only composition of the food product is in the form of a gel or liquid. In some embodiments, the food product comprises a dessert product, ice cream, a frozen dessert, bakery and baked product, confectionary product, or milk-based beverages. In some embodiments, the dessert product comprises any of ice cream, frozen custard, ice milk, frozen yogurt, sherbet, water ices, whipped creams or edible dipping sauces.

In some embodiments, the plant-only composition comprises lipids, polysaccharides, proteins and chemical compounds that are similar to those present in dairy based and/or egg-based ingredient. In some embodiments, the dairy ingredient comprises any of milk, milk cream, butter, fermented milk product, yogurt, cheese, custard, frozen, or casein.

In some embodiments, the plant-only composition comprises (i) about 7% to 25% weight by weight of a plant-derived cream; (ii) about 1% to 5% weight by weight of a plant seed mucilage; (iii) about 1% to 5% weight by weight of a fruit and/or vegetable mucilage; (iv) about 5% to 15% weight by weight of a plant-derived protein; (v) about 25% to 50% weight by weight of a plant-derived milk; (vi) about 0.5% to 5% weight by weight of a plant-derived lactone enhancer; (vii) about 0.5% to 5% weight by weight of a plant-derived flavor enhancer; and (viii) about 2% to 5% weight by weight of a plant-derived nutrient enhancer. The plant-only composition substitutes a diary ingredient in the food product.

In one aspect, a food product comprising a plant-only composition is provided. The plant-only composition comprises (i) about 5% to 40% weight by weight of a plant-derived cream; (ii) about 0.5% to 10% weight by weight of a plant seed mucilage; (iii) about 0.5% to 10% weight by weight of a fruit and/or vegetable mucilage; (iv) about 2% to 20% weight by weight of a plant-derived protein; (v) about 15% to 60% weight by weight of a plant-derived milk; (vi) about 0.1% to 10% weight by weight of a plant-derived lactone enhancer; (vii) about 0.1% to 10% weight by weight of a plant-derived flavor enhancer; and (viii) about 0.5% to 10% weight by weight of a plant-derived nutrient enhancer. The plant-only composition substitutes a diary ingredient in the food product.

In some embodiments, the plant-only composition present in the food product ranges from about 1% to 20% weight by weight of the food product.

In another aspect, a dairy replacement composition for a food product comprising a plant-only composition is provided. The plant-only composition comprises: (i) about 5% to 40% weight by weight of a plant-derived cream; (ii) about 0.5% to 10% weight by weight of a plant seed mucilage; (iii) about 0.5% to 10% weight by weight of a fruit and/or vegetable mucilage; (iv) about 2% to 20% weight by weight of a plant-derived protein; (v) about 15% to 60% weight by weight of a plant-derived milk; (vi) about 0.1% to 10% weight by weight of a plant-derived lactone enhancer; (vii) about 0.1% to 10% weight by weight of a plant-derived flavor enhancer; and (viii) about 0.5% to 10% weight by weight of a plant-derived nutrient enhancer, wherein the plant-only composition substitutes a diary ingredient in the food product.

In another aspect, a process of preparing a plant-only composition for a food product is provided. The process comprising: (i) soaking raw materials for a plant-derived milk in water having a temperature ranging from 30° C. to 40° C. for 10-12 hours at a ratio of 1:10; (ii) decanting the soaked raw materials for 2-4 minutes for removing water; (iii) rinsing the decanted raw materials with water having a temperature ranging from 30° C. to 40° C.; (iv) grinding/blending the rinsed raw materials with water in a ratio of 5:1 at a temperature ranging from 30° C. to 40° C. for extracting the plant-derived milk; and (v) adding a plant-derived cream, a plant seed mucilage, a fruit and/or vegetable mucilage, a plant-derived protein, a plant-derived lactone enhancer, a plant-derived flavor enhancer, and a plant-derived nutrient enhancer to the plant-derived milk at a temperature ranging from 42° C. to 49° C. to obtain a plant-only composition.

In some embodiments, the process comprises steeping the plant-derived milk for one hour at a temperature ranging from 25° C. to 30° C., and filtering the plant-derived milk using a cheese cloth before adding the plant-derived milk to the plant-derived cream, the plant seed mucilage, the fruit and/or vegetable mucilage, the plant-derived protein, the plant-derived lactone enhancer, the plant-derived flavor enhancer, and the plant-derived nutrient enhancer.

In some embodiments, the process comprises (i) filtering the plant-only composition for discarding solids; (ii) preheating the plant-only composition at a temperature ranging from 50° C. to 80° C.; (iii) homogenizing the plant-only composition at 2100 Psi to 4300 Psi for 3-30 minutes; and (iv) pasteurizing the plant-only composition at a temperature ranging from 63° C. to 67° C. for 28 to 40 minutes or 72° C. to 75° C. for 10 to 20 seconds.

In some embodiments, the process comprises (i) bottling the plant-only composition, followed by pasteurizing the bottled plant-only composition at a temperature ranging from 85° C. to 90° C. for 1 to 4 seconds; and (ii) cooling the plant-only composition at a temperature ranging from 4° C. to 6° C. and storing it at a temperature less than 4° C.

The present composition can be used as an alternative/substitute for an egg ingredient or a milk/diary ingredient in the food products, for example, ice creams. The present composition replaces conventional egg and milk ingredients in food products that consists of minimally processed, plant-only ingredients while ensuring desirable flavor, texture, appearance and taste as well as the same or similar functionality of conventional dairy ingredients for the food product to which the composition is incorporated.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications. Further, one skilled in the relevant art will recognize that the embodiments can be practiced without one or more of the specific details or with other methods, components, materials and so forth. In other instances, well-known structures, materials, or operations are not shown in detail to avoid obscuring the features of the embodiments. Furthermore, the features/aspects described can be practiced in various combinations, though only some of the combinations are described herein for conciseness.

### BRIEF DESCRIPTION OF THE DRAWINGS

The embodiments herein will be better understood from the following detailed description with reference to the drawings, in which.

FIG. 1 illustrates a plant-only composition for a food product according to some embodiments herein;

FIG. 2 illustrates a process of preparing a plant-only composition for a food product according to some embodiments herein;

FIG. 3 illustrates an exemplary illustration of the emulsion stability of a plant-derived protein at various pH according to some embodiments herein;

FIG. 4 illustrates an energy and minimum nutrient criteria of a plant-derived nutrient enhancer for a plant-only composition applied according to some embodiments herein; and

FIG. 5 illustrates a flow diagram of a process of preparing a plant-only composition for a food product according to some embodiments herein.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments.

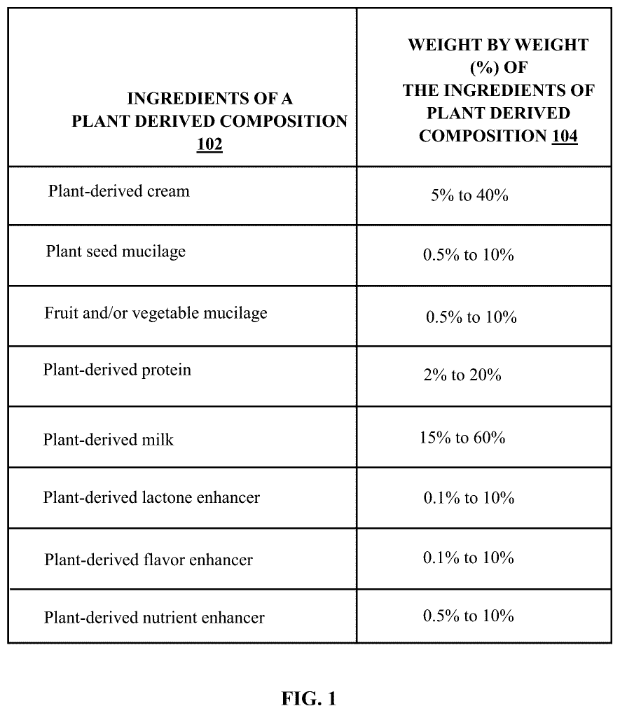

Referring now to the drawings, and more particularly to FIGS. 1 through 5, where similar reference characters denote corresponding features consistently throughout the figures, there are shown preferred embodiments.

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another.

The terms “comprising”, “comprises” and “comprised of” as used herein are synonymous with “including”, “includes” or “containing”, “contains”, and are inclusive or open-ended and do not exclude additional, non-recited members, elements or method steps.

The “Plant-only” products disclosed herein, as opposed to products labeled as “plant-based,” and the like, refer to food products whose ingredients, apart from any significant amount of water added, are derived solely from sources outside of the animal kingdom, e.g., from plants, fungi, or algae. That is, “plant-only” may refer to any agent, ingredient, or component of a food product, or the entire food product itself, that is produced, developed, or otherwise obtained directly or indirectly from one or more plants, fungi, or algae, is not synthetic, and is only minimally processed for production, e.g., cleaned, dried, pulverized, etc.

While some manufacturers may refrain from including any ingredients sourced from animals in their “plant-based” (and other similarly labeled) products, the term “plant-based” may also encompass ingredients and food products that may be obtained from animals. The US Food and Drug Administration currently has no accepted standard definition for labeling of food products described as “plant-based” although a private trade organization, the Plant Based Food Association, has proposed voluntary standards to ensure consistency when the term “plant-based” is used on a product label (i.e., it contains no animal-sourced content), and seeks to certify-through its own certification process—food products, including food product mixes, that meet this standard See https://www.plantbasedfoods.org/policy/labeling/. The terminology used on a label for a plant-based food must be truthful under FDA regulations; however, in the US, no regulatory body currently requires a company to refrain from including some amount of meat, seafood, or other animal-sourced ingredients in a “plant-based” product.

The term “food product” refers broadly to any edible good or product, raw or cooked, savory or sweet, whether intended for human or animal consumption; a food product may be edible although not intended to be consumed on its own but, rather, incorporated into a second (or third) food product that is considered a consumable. The plant-only composition disclosed herein in certain embodiments may be incorporated into or used with meat-based food products; in other embodiments it may be incorporated into or used with seafood-based food products; in still other embodiments, it may be incorporated into or used with plant-based food products. In certain preferred embodiments, the plant-only composition may be incorporated into or used with plant-only food products, including breads and other baked and fried foods.

In certain embodiments, while some of the water content of a food product may be derived from a plant source, water may also be added to the product from an external source. For example, in scenarios in which a plant-derived agent or composition or plant-only food product is in the form of a gel or liquid, it is further understood that water can be included as solvent or liquid carrier for the plant-only composition, ingredient or food product, where any amount of water (some or all) within the composition, ingredient or food product may or may not be derived from a plant source. Further, the plant-only or plant-derived ingredients can be fresh sourced (i.e., obtained from a particular plant source with no processing). Alternatively, the plant-only or plant-derived ingredients can be minimally processed such as in ways described herein (e.g., freeze dried, pulverized or pureed, extracted from a fresh sourced portion of a plant, etc.). In some embodiments, water may be added from an external source as part of the plant-only composition (or any other plant-only composition referenced herein). In other embodiments the plant-only composition may be available in a dried form; in certain embodiments the dried form may be powdered; in other embodiments, the dried form of the plant-only composition may be in a partially powdered form; in other embodiments it may be available in a semi-liquid or gel form; in other embodiments it may be in a liquid or frozen form.

In the disclosed embodiments, apart from externally-sourced water, the plant-only food product consists entirely of ingredients derived from plants, fungi or algae, excluding any component or ingredient that is: (i) dairy-based or otherwise derived from any member of the animal kingdom; and (ii) more than minimally processed; and (ii) synthetic.

Alternative embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, regardless of whether it is expressly described herein, one of ordinary skill in the art would readily appreciate that each of the particular features, structures, or characteristics of the given embodiments may be utilized in connection or combination with those of any other embodiment discussed herein.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

Further, the terms “comprising,” “including,” “having,” and the like, as used with respect to embodiments of the present disclosure, are synonymous. As used herein, the terms “agent,” “component,” or “ingredient” are used interchangeably and refer to a particular item that includes one or more chemical compounds (e.g., a food item from one or more plants that comprise one or more naturally occurring chemical compounds).

The term “component” or “ingredient” as used herein, refers to a particular item that includes one or more chemical compounds, i.e., edible compounds sourced from plants, fungi or algae that comprises one or more naturally occurring chemical compounds. Selection of specific plant-derived ingredients, or specific combinations of plant-only or plant-derived ingredients, provide effective functionalities for dairy replacement additives in a food product (e.g., a plant-only food product). As used herein, the term “component” or “ingredient” refers to a particular item that includes one or more chemical compounds (e.g., a food/edible parts from the plant species that comprises one or more naturally occurring chemical compounds).

In example embodiments, the plant-only food product includes a combination of components or ingredients from the plant genus that render the combination (in the amounts as indicated) particularly suitable as a dairy replacement agent or composition for a food product. In such embodiments, the plant-only dairy replacement composition is added to other food ingredients to form a final food product formulation that requires such dairy replacement composition/system. Examples of food products that utilize dairy replacement additives include, without limitation, dessert like products such as ice cream, creamy products such as whipped creams, edible dipping sauces, etc.

### Charaka Machine Learning (ML) Platform and the Ancestral Wisdoms Data System

In general, the selection of a specific combination of ingredients for plant-only composition/products was determined using a proprietary machine learning (ML) platform, which blends ancestral wisdoms of plant nutrition with biotechnology and ML to analyze members of, primarily, the plant and fungi kingdoms, as well as other potential, natural, sources outside of the animal kingdom for the compound nature offers. The platform utilizes algorithms and includes a database with a significant number of ingredients (e.g., 50,000-100,000 ingredients) and relevant physical properties associated with such ingredients. For example, physical characterization data and information about each ingredient for some or all of the ingredients in the database include, without limitation, functional properties (e.g., emulsification properties, stabilization properties, gelling properties, fat-replacement properties, dairy replacement properties, etc.). Ayurvedic and/or other properties derived from ancestral wisdom, physicochemical properties (e.g. pH, viscosity, moisture content, density, etc.), mechanical properties (e.g. adhesive strength, tensile strength, shear resistance, etc.), chemical and/or molecular descriptor properties (e.g., bio-active/bioavailability properties, molecular structure, phytonutrient properties, etc.), sensorial properties (e.g., taste, smell, color, texture, mouth feel, etc.), and nutritional information (e.g., macronutrient/micronutrient properties, etc.) are also considered in the proprietary system to give optimal results in terms of functionality, health and sustainability. Based upon the known properties of ingredients in the database, the desired properties for the food product or formulation, and one or more algorithms associated with the proprietary machine learning platform, a unique combination of plant-derived ingredients was determined to yield an effective plant-only composition that can be used to create a desirable food product or formulation that is effective as a substitute for conventional dairy ingredients in food products of all kinds.

As noted, the proprietary system identifies natural alternatives, i.e., as defined, “plant-only” alternatives to synthetic, artificial, and animal-derived products, and incorporates in its algorithms, among other things, ancestral or traditional knowledge from systems such as Ayurvedic medicine. Ayurvedic medicine and its diet principles have been practiced for many thousands of years. This ancient system, among other things, categorizes food by its medicinal properties and desired effects; thus, the proper application of Ayurvedic principles requires knowledge of the self—one's dominant energy, also known as dosha—to prescribe the most advantageous categories of foods from which to choose for an individual's diet. Categories of Ayurvedic properties include but are not limited to Virya (hima/sheeta—cold), Vipaka (Madhura—sweet), Rasa (Madhura—sweet), and Guna (ruksa—dry; or guru—heavy). Such similar ancestral wisdoms exist in other parts of the world such as the Traditional Chinsese Medicine, Amazonian rainforest ancestral wisdom which may also be used as part of Charaka. The information recommended by the proprietary Charaka system permits one to choose among hundreds of alternatives based on ingredients intended to alter a variety of properties to give optimal results for dairy replacement purposes as well as physiological functionality, health, and environmental sustainability.

### Terms and Definitions:

As used in the present invention, the following terms are generally intended to have the meaning as set forth below, except to the extent that the context in which they are used indicate otherwise.

Cream: Cream is a dairy product composed of the higher-fat layer skimmed from the top of milk before homogenization.

Protein: Proteins are large biomolecules and macromolecules that comprise one or more long chains of amino acid residues.

Fat: Fat refers to a type of lipid consisting of esters of glycerol and fatty acids or triglycerides.

Mucilage: Mucilage is a thick, gluey substance produced by plants or plant parts such as fruit, seed, or vegetable.

Enhancer: An enhancer is a substance that makes a particular thing look, taste, or feel better.

Flavor enhancer: Flavor enhancer is a compound that are added to a food product in order to supplement or enhance its own natural flavor.

Nutrient enhancer: Natural or synthetic nutrient is a compound that is added to a food product to improve the nutrition value of the food product.

Lipid: Lipids are a broad group of naturally-occurring molecules which includes fats, waxes, sterols, fat-soluble vitamins, monoglycerides, diglycerides, phospholipids, and others.

Stirring: Stirring is a process of mixing a substance(s) in a circular pattern using a spoon, spatula or other such utensil.

Centrifuging: Centrifuging is a process that uses centrifugal force for the separation of two liquids in a mixture.

Globulin: Globulins are a family of globular proteins that have higher molecular weights than albumins and are insoluble in pure water but dissolve in dilute salt solutions.

Albumin: Albumin is a family of globular proteins, the most common of which are the serum albumins. All the proteins of the albumin family are water-soluble, moderately soluble in concentrated salt solutions, and experience heat denaturation.

Gel: A gel is a semi-solid that can have properties ranging from soft and weak to hard and tough. Gels are defined as a substantially dilute cross-linked system, which exhibits no flow when in the steady-state, although the liquid phase may still diffuse through this system.

Cross-linked gel: Cross-linked gels are a class of gels that are based on cross-linked polymeric systems.

Polysaccharide entanglement: Entanglement refers to a reticular or spherical structure formed by the cross-linking points produced in the polymer chain, or in between polymer chains, making the polymer chains unable to move normally and thus affecting the nature of the polymer.

Molecular weight: Molecular weight is a mass of a given molecule. The molar mass/molecular weight is the sum of the total mass in grams of the atoms present to make up a molecule per mole.

Water holding capacity (WHC): Water-holding capacity (or water-binding capacity, or water-absorption capacity) is a measure of the total amount of water that can be absorbed per gram of a powder/composition/ingredients.

Oil absorption capacity (OAC): Oil absorption capacity is defined as the difference in the powder weight before and after its oil absorption.

Foaming capacity: The good foaming capacity of mucilage is highly associated with the flexible structure of mucilage that can reduce the surface tension. Foaming properties of proteins depend on their ability to form flexible, elastic, cohesive interfacial film which is capable of entrapping and retaining air that leads to enhanced air bubbles, resulting in excess volume of the frozen sample.

Viscosity: Viscosity is the resistance of a fluid (e.g. liquid or gas) to a change in shape or movement of neighbouring portions relative to one another. Viscosity denotes opposition to flow.

Solubility index: Solubility index is a measure of the solubility of the component or ingredient in a substance The value reflects variation in ingredient processing.

Zeta potential (ZP): Zeta potential is a physical property which is exhibited by any particle in suspension, macromolecule or material surface. It can be used to optimize the formulations of suspensions, emulsions and protein solutions, predict interactions with surfaces, and optimise the formation of films and coatings. Surface charge has a direct impact on emulsion characteristics, i.e. larger magnitude=more surface charge, usually negative for proteins.

Isoelectric point-pH: Isoelectric point (-pH) where protein precipitates and usually is least functional. The protein has better functionality such as solubility at pH below or above the isoelectric point.

Emulsion ability: Emulsion capacity or activity reflects the ability of the proteins to aid formation and stabilization of the newly created emulsion or two phase emulsion system.

Emulsion stability: Emulsion stability is the capacity of emulsion droplets to remain dispersed without separation by creaming, coalescing, and flocculation over time.

Amount of calories: Amount of calories may provide no energy calories or structured lipid molecules which provide reduced energy calories.

pH: pH is a measure of the hydrogen ion concentration in solution and is also referred to as the degree of acidity or alkalinity.

Plant-derived: “Plant-derived” refers to ingredients extracted from a plant.

Functional properties such as the interaction with other stabilizers, emulsion stabilization structure formation, and water retention capabilities, which improves the mixture viscosity, increases melting point and reduces ice formation.

In an embodiment herein provide a plant-only composition for a food product. The plant-only composition comprises (i) about 5% to 40% weight by weight of a plant-derived cream; (ii) about 0.5% to 10% weight by weight of a plant seed mucilage; (iii) about 0.5% to 10% weight by weight of a fruit and/or vegetable mucilage; (iv) about 2% to 20% weight by weight of a plant-derived protein; (v) about 15% to 60% weight by weight of a plant-derived milk; (vi) about 0.1% to 10% weight by weight of a plant-derived lactone enhancer; (vii) about 0.1% to 10% weight by weight of a plant-derived flavor enhancer; and (viii) about 0.5% to 10% weight by weight of a plant-derived nutrient enhancer. The plant-only composition substitutes a diary ingredient in the food product.

In some embodiments, the plant-only composition comprises (i) about 7% to 25% weight by weight of a plant-derived cream; (ii) about 1% to 5% weight by weight of a plant seed mucilage; (iii) about 1% to 5% weight by weight of a fruit and/or vegetable mucilage; (iv) about 5% to 15% weight by weight of a plant-derived protein; (v) about 25% to 50% weight by weight of a plant-derived milk; (vi) about 0.5% to 5% weight by weight of a plant-derived lactone enhancer; (vii) about 0.5% to 5% weight by weight of a plant-derived flavor enhancer; and (viii) about 2% to 5% weight by weight of a plant-derived nutrient enhancer. The plant-only composition substitutes a diary ingredient in the food product.

In one aspect, a food product comprising a plant-only composition is provided. The plant-only composition comprises (i) about 5% to 40% weight by weight of a plant-derived cream; (ii) about 0.5% to 10% weight by weight of a plant seed mucilage; (iii) about 0.5% to 10% weight by weight of a fruit and/or vegetable mucilage; (iv) about 2% to 20% weight by weight of a plant-derived protein; (v) about 15% to 60% weight by weight of a plant-derived milk; (vi) about 0.1% to 10% weight by weight of a plant-derived lactone enhancer; (vii) about 0.1% to 10% weight by weight of a plant-derived flavor enhancer; and (viii) about 0.5% to 10% weight by weight of a plant-derived nutrient enhancer. The plant-only composition substitutes a diary ingredient in the food product.

In another aspect, a dairy replacement composition for a food product comprising a plant-only composition is provided. The plant-only composition comprises: (i) about 5% to 40% weight by weight of a plant-derived cream; (ii) about 0.5% to 10% weight by weight of a plant seed mucilage; (iii) about 0.5% to 10% weight by weight of a fruit and/or vegetable mucilage; (iv) about 2% to 20% weight by weight of a plant-derived protein; (v) about 15% to 60% weight by weight of a plant-derived milk; (vi) about 0.1% to 10% weight by weight of a plant-derived lactone enhancer; (vii) about 0.1% to 10% weight by weight of a plant-derived flavor enhancer; and (viii) about 0.5% to 10% weight by weight of a plant-derived nutrient enhancer. The plant-only composition substitutes a diary ingredient in the food product.

In yet another aspect, a process of preparing a plant-only composition for a food product is provided. The process comprising: (i) soaking raw materials for a plant-derived milk in water having a temperature ranging from 30° C. to 40° C. for 10-12 hours at a ratio of 1:10; (ii) decanting the soaked raw materials for 2-4 minutes for removing water; (iii) rinsing the decanted raw materials with water having a temperature ranging from 30° C. to 40° C.; (iv) grinding/blending the rinsed raw materials with water in a ratio of 5:1 at a temperature ranging from 30° C. to 40° C. for extracting the plant-derived milk and (v) adding a plant-derived cream, a plant seed mucilage, a fruit and/or vegetable mucilage, a plant-derived protein, a plant-derived lactone enhancer, a plant-derived flavor enhancer, and a plant-derived nutrient enhancer to the plant-derived milk at a temperature ranging from 42° C. to 49° C. to obtain a plant-only composition.

FIG. 1 illustrates a plant-only composition for a food product according to some embodiments herein. FIG. 1 includes ingredients 102 of the plant-only composition and weight 104 of the ingredients 102 of the plant-only composition. The plant-only composition comprises (i) about 5% to 40% weight by weight of a plant-derived cream; (ii) about 0.5% to 10% weight by weight of a plant seed mucilage; (iii) about 0.5% to 10% weight by weight of a fruit and/or vegetable mucilage; (iv) about 2% to 20% weight by weight of a plant-derived protein; (v) about 15% to 60% weight by weight of a plant-derived milk; (vi) about 0.1% to 10% weight by weight of a plant-derived lactone enhancer; (vii) about 0.1% to 10% weight by weight of a plant-derived flavor enhancer; and (viii) about 0.5% to 10% weight by weight of a plant-derived nutrient enhancer. The plant-only composition substitutes a diary ingredient in the food product.

Selection of a specific combination of plant-derived ingredients 102 for a plant-only dairy replacement (e.g., milk and egg substitute) composition is determined using a proprietary machine learning platform that utilizes algorithms and includes a database with a significant number of ingredients (e.g., 50,000-100,000 ingredients) and relevant physical properties associated with such ingredients.

For example, physical characterization data and information about each ingredient for some or all of the ingredients in the database include, without limitation, functional properties (e.g. emulsification properties, stabilization properties, gelling properties, fat-replacement properties, dairy replacement properties, etc.), ayurvedic and/or Rasa, Guna, Snigdha, Virya, Vipaka, etc. and other holistic properties, physicochemical properties (e.g. pH, viscosity, moisture content, density, etc.), mechanical properties (e.g. adhesive strength, tensile strength, shear resistance, etc.), chemical and/or molecular descriptor properties (e.g., bio-active/bioavailability properties, molecular structure, phytonutrient properties, etc.), sensorial properties (e.g., taste, smell, color, texture, mouth feel, etc.), and nutritional information (e.g., macronutrient/micronutrient properties, etc.).

In an embodiment, the physical characterization data associated with the ingredients of the plant-only composition comprises the protein, fiber, cream, starch, sweetener, thickener, emulsifier-stabilizer system, fat, anti-freezing agent, and anti-caking agent is stored in a database. A machine learning model determines a unique combination of ingredients based on the physical characterization data to prepare the plant-only composition. The machine learning model identifies plant-derived ingredient for dairy replacements based on the parameters and ranges provided in Table 1 to give the list of ingredients for each possible functionality. The “Machine learning model” refers to computer software designed to recognize patterns or behaviors based on previous experience or data.

Based upon the known properties of ingredients in the database, the desired properties for the food product or formulation, and one or more plant-derived components or ingredients is determined to yield an effective formulation that can be used as a dairy replacement component or ingredient or composition for food-based products and, in particular, plant-only food products for the plant-derived food industry.

Plant-derived dairy replacement ingredients 102 are selected to provide suitable lipids, polysaccharides, proteins and other chemical compounds that are similar to those present in milk based and egg based ingredients. The plant-derived ingredients 102 are minimally processed so as to maintain as much of their same properties as in their natural form. As noted herein, a combination of ingredients 102 that provide desirable dairy replacement functionalities for food products comprise one or more of the following: plant-derived cream (e.g., coconut cream, cashew cream, any other type of cream from nuts), plant seed mucilage (e.g., flax seed mucilage and/or basil seed mucilage), a polysaccharide rich fruit or vegetable mucilage (e.g., okra mucilage and/or mangosteen mucilage), plant protein source (e.g., from legumes or seeds, such as beans, peas, chickpeas, peanuts, lentils, etc.), plant-derived milk source (e.g., milk from seeds such as hemp), plant-derived lactone enhancer (e.g., plants such as peach and/or carrot), plant-derived flavor enhancer e.g., kithul obtained as sap extracted from the kitul palm, Caryota urens plant species), and a plant-derived nutrient enhancer (e.g., berries such as blueberries, strawberries, etc.).

The selection of each plant-derived ingredient 102 and its properties which render it useful in combination with one or more of the other ingredients 102 as a dairy replacement composition is described as follows. Water can also be added to this mixture of plant-derived ingredients 102 to provide an aqueous based system that also controls a viscosity of the composition.

In some embodiments, the plant-derived cream comprises at least one of coconut cream, rice cream, cashew cream, sesame seeds cream, cassava cream, oat milk cream, white bean cream, tofu cream, three leaf yam cream, sweet potato cream, sunflower seeds cream or a combination thereof. For example, the plant-derived cream such as coconut cream is useful for the plant-only composition/dairy replacement composition in that it provides a high lipid content with medium chain fatty acids such as lauric, linoleic and oleic acids (where 70% of the total fatty acid content is lauric acid). The plant-derived cream enhances the creamy texture, feel and taste of the composition and the food product that incorporates the composition. The plant-derived ice cream (e.g., coconut cream) provides not only the fatty acids that mimic dairy-based fats but also functions as a thickener due to its thick and creamy consistency, thus increasing the viscosity of the composition and the food product.

In addition, the caloric content of coconut cream is much lower than conventional dairy-based milks and creams. Coconut cream can be particularly useful in the dairy replacement ingredient when the plant-only composition is incorporated within a frozen dessert product, where the coconut cream aids in the enhancement/increase in melting time and reducing overrun of the frozen dessert product. In an example, the plant-based creams (i.e. silkier ice creams) are made with creams with at least 16% of fats. In some embodiments, the cashew cream has an emulsion stability of up to 98%.

In some embodiments, the plant seed mucilage comprises at least one of flax seed mucilage, basil seed mucilage, chia seeds mucilage, psyllium seed mucilage, Balangu seed mucilage, quince seed mucilage, Arabidopsis seed coat mucilage, yellow mustard seed mucilage, sage seed mucilage, Ipomoea digitata seed mucilage, Eruca sativa seed mucilage or a combination thereof.

The seed mucilage and, in particular the flax seed mucilage and/or the basil seed mucilage, comprises polysaccharides that provide properties similar to those in eggs. For example, the flax seed is rich in fiber, protein as well as fatty acids including Omega 3 and Omega 6 fatty acids, and also Alpha Linoleic acid. The flax seed, when processed to form a mucilage, adds an oily, sticky and slimy texture that is similar to an egg product, and further provides a flavor profile that is nutty, sweet, oily and slightly bitter.

In some embodiments, the flax seed mucilage comprises soluble fiber in an amount of about 7-10% weight by weight of the flax seed mucilage, about 80% weight by weight neutral and acidic polysaccharides and about 9% weight by weight protein. The neutral monosaccharides comprise xylose, glucose, arabinose, and galactose, while acidic monosaccharides comprise rhamnose, galactose, fructose, and galacturonic acid. The flax seed mucilage, when combined with the other ingredients for the system, can provide thickening (increased viscosity), texturizing and gelation characteristics for the system as well as enhancing dispersion properties of fat droplets in a food product. The basil seed mucilage or other seed mucilage as disclosed above includes similar properties, and both are useful in increasing viscosity of the composition and the food product as well as enhancing certain types of food products such as frozen dessert products by improving overrun, and reducing melting rate.

In some embodiments, any conventional or other suitable process can be used to convert flax seed, basil seed or other seed mucilage as disclosed above to a mucilage. An example embodiment of converting flax seeds into flax seed mucilage for use in the dairy replacement composition/plant-only composition as described herein comprises washing flax seeds to remove surface dust and then stirred with distilled water for a suitable time and temperature and at a suitable speed in a mixer to form a mucilage. A specific example describing a method of forming a mucilage from flaxseed is described by S. W. Cui, Polysaccharide gums from agricultural products: Processing, structures and functionality, Technomic Publishing Co., Inc., Lancaster PA (2001), the contents of which are incorporated herein by reference in its entirety.

For example, the flax seeds can be stirred for about 5 hours in distilled water at about 60° C. and at a mixing speed of about 300 revolution per minute (rpm). The mucilage can be separated from solution by filtering, e.g., through a 40-mesh screen, then precipitated with 95% ethanol, followed by further separation by centrifugation (e.g., at 3000 rpm for about 10 minutes). The precipitated flax seed mucilage can then be dried in a hot air over at a temperature of about 60° C. It is noted that any other conventional method for forming flax seed mucilage from natural flax seeds can also be performed to obtain the flax seed mucilage.

In some embodiments, the molecular weight is an important indicator of the quality of a mucilage because the polymer chains interact when the mucilage dissolves, and the mucilage with a high molecular weight can improve its viscosity. The solubility of mucilage also improves with increasing temperatures. Another property of mucilage is its ability to retain water (i.e. Water holding capacity, WHC), which is dependent on pore size, capillary action and the amount of protein components present in the mucilage. For example, the flax mucilage has a higher water retention capacity compared to a microbial xanthan mucilage.

For example, the basil seed mucilage has a Water holding capacity (WHC) of about 35.16-38.96 g·g−1 and the chia seed mucilage has a WHC of about 54.24±0.47 g·g−1. The psyllium seed gum that is added in the composition has a WHC more than 1000 g/g. Further, the seed mucilage has improved Oil absorption capacity (OAC) as fat acts as a flavor retainer and also increases soft texture to the mouthfeel of foods. For example, the basil seed mucilage has OAC of about 5.40-17.38%.

In some embodiments, the fruit and/or vegetable mucilage comprises at least one of okra mucilage, mangosteen mucilage, moringa mucilage, assyrian plum mucilage, prickly pear mucilage, cassava mucilage, spinach leaves mucilage, Basella alba mucilage, Indian jujube fruit mucilage, coromandel ebony mucilage, orange fiber mucilage, tilkor fruit mucilage or a combination thereof.

In some embodiments, the fruit and/or vegetable mucilage, such as okra mucilage or mangosteen mucilage, provides bulking, thickening and stabilizing properties for the system. For example, the okra mucilage comprises a polysaccharide rich material including galactose, rhamnose and galacturonic acid at concentrations between 20% and 30%, also comprising 11% of protein, 40% of carbohydrates, 10% of moisture, 10% of ash, 0.5% of magnesium, about 3.0% of calcium, and also potassium (0.1-0.7%) and phosphorus (0.14-0.18%). The okra mucilage can be extracted by any number of conventionally known methods. For example, okra pods can be cooked to produce a viscous and slimy mucilage, which comprises a polysaccharide-rich hydrocolloid.

The okra polysaccharides comprise acidic polysaccharides composed of glucose, galactose, rhamnose, galacturonic acid and glucuronic acid. The mucilage or gum also contains pectin, and these pectin components can build a cross-linked gel in water in the presence of calcium ions. These gel cross-linked networks or polysaccharide entanglements, mimic the physical and sensory characteristics of emulsified fats that simulate milk fats (e.g., fats in frozen dessert products such as ice cream). The methods for forming okra mucilage can directly influence its physicochemical characteristics and biological activity such that polysaccharides in the mucilage contribute to providing properties for the plant-only composition like water holding capacity and binding capacity. The okra mucilage further provides benefits for frozen dessert products such as ice cream (e.g., reducing overrun in the food product).

In some embodiments, the okra mucilage has a foaming capacity of 30 to 65% of 1% w/v respectively, the flax seed mucilage has a foaming capacity of about 75%, and the Plantago seed mucilage has a foaming stability of 88.4%. In some embodiments, the concentration of mucilage increases, when its viscosity increases. For example, the basil seed mucilage has a viscosity that ranges from 0.19 to 0.714 pascal second (Pa/s). The fruit and/or vegetable mucilage may act as fat substitutes which maintain the palatability of foods as they can reproduce the texture and mouthfeel of fat. Further, lower pH values of mucilage are likely to improve protein recovery due to protein solubilization. Although, below 3 pH, the action of acid may result in a lower protein yield due to its hydrolysis. The mucilage has good oil absorption capacity which improves the texture of the food product. The fruit or extracted mucilage has good oil binding capacity due to presence of monopolar molecules, therefore, it can trap higher amounts of oil particles and also prevent oil and the loss of flavor from food products.

In some embodiments, the mangosteen mucilage is obtained from mangosteen fruit and can be formed in a manner similar to as disclosed the formation of okra mucilage. The mangosteen mucilage also includes polysaccharides that provide physical and sensory characteristics that mimic milk fats. In particular, the mangosteen mucilage includes neutral arabinoxylans and acidic pectin-like rhamnogalacturonan as well as xanthones and vitamins. The xanthones are strong antioxidants, and the most significant xanthone found in mangosteen is a-mangostin. Addition of the mangosteen mucilage to the plant-only composition enhances the organoleptic and other properties of the plant-only composition.

In some embodiments, the plant-derived protein comprises at least one of pea protein, soy protein, potato protein, chickpea protein, quinoa protein, black lentil protein, peanut protein, almond protein, chia seed protein, pinto bean protein, oat protein, melon seed protein or a combination thereof. A suitable plant-derived protein source (e.g., from legumes or seeds, such as beans, peas, chickpeas, peanuts, lentils, etc.) provides proteins that are substitutes for milk and egg proteins and further provide bulking and thickening to the plant-only composition and the food product to which the plant-only composition is added.

For example, the pea protein includes 7S and 11S globulin proteins as well as 2S albumin proteins that simulate milk and egg proteins. The pea proteins or other protein as disclose above can be extracted in any suitable manner from peas, and they improve viscosity of the plant-only composition and food product. The pea proteins also account for the lack or reduced amount of proteins present in the coconut cream, and further exhibit good emulsifying and stabilizing properties that help in improving the stability of a plant-only dairy product. Addition of pea protein leads to rise in flow resistance and melting resistance as there is increase in viscosity. Due to the liquid binding property of the pea protein, there is formation of a stable gel network leading to immobilization of water molecules.

In some embodiments, the plant-derived protein has a solubility that is usually at a minimum at its isoelectric point. For example, the soy protein has a solubility of 52%, and the pea protein has a solubility of 13%. Hence the requirement to choose plant-derived proteins in ranges of pH below 4 and above 5. In some embodiments, the plant-derived protein has more Zeta potential (ZP), which means that the particles may tend to repel each other and there may be no tendency for the particles to come together. Hence, the plant-derived protein has a smooth and less gritty texture. For example, the pea protein has a zeta potential of −23 millivolt (mV), and the soy protein has a zeta potential of −24 mV. In some embodiments, the plant-derived protein has a Molecular weight that is in the range of 10-50 kilodalton (kDa). Proteins of less than 10 kDa are weak fiber builders, whereas those higher than 50 kDa are disadvantageous due to their high viscosity and their tendency to gel in the alkaline pH range.

In some embodiments, the soy protein has an isoelectric point of about 4-5. In some embodiments, the potato protein has an isoelectric point of 4.9. In some embodiments, the chickpea protein has an isoelectric point of 4. In some embodiments, the quinoa protein has an isoelectric point of 4.5. If the plant-derived protein has more protein content, it produces more a viscous gel matrix, which may affect air incorporated during the freezing process, and provide ice cream samples with decreased overrun. In some embodiments, the pea protein has an isoelectric point of approximately 4.3. In some embodiments, the pea proteins have the best emulsifying ability due to the small droplet size. The solubility is either high between pH 1 to 3 and pH 7 to 10, and low at the isoelectric point. This is due to the net zero charge of the protein. The plant-derived protein may bestow the required hardness or structure due to protein. The plant-derived protein has a high water-holding and binding capacity, which causes the formation of a gel matrix which in turn results in a more stable and more viscous product.

In some embodiments, the plant-derived milk comprises at least one of hemp seed milk, oat milk, soy milk, potato milk, almond milk, sesame milk, macadamia milk, hazelnut milk, lupin milk, coconut milk, cowpea milk or a combination thereof. The plant-derived milk, such as the hemp seed milk, serves as a substitute for animal derived milk. For example, the hemp seed provides a high quality protein source that contains all essential amino acids. The hemp seed milk can be an effective substitute for animal derived, dairy based milk, because of its polyunsaturated fatty acids, essential fatty acids and other fat-soluble bioactive compounds. Typically, the bovine milk has 20 amino acids and eggs have a complete amino acid profile. Hence, presence of 9 essential amino acids is an important factor that needs to be considered for having a suitable plant milk. The hemp milk includes all essential amino acids, making it a complete protein. Most of the fat in hemp milk is unsaturated, including omega-3 and omega-6 fatty acids. The plant-derived milk provides health benefits due to having less saturated fats, and less allergy/adverse reaction potential to people in relation to dairy based milk.

In some embodiments, the plant-derived lactone enhancer present in the plant-only composition ranges from about 0.3% to 7% weight by weight of the composition. The plant-derived lactone enhancer can be provided from fruit and/or vegetable plant sources such as peaches, carrots apricots, raspberries, strawberries, pineapple, plums, celery, coconut, orange, filberts, peanuts or a combination thereof. The lactones from fruits and/or vegetables provide a milky and creamy scent to the plant-only composition/dairy replacement composition.

In some embodiments, the plant-derived flavor enhancer comprises at least one of kithul, raisins, durian, pears, prunes, monk fruit, sapodilla, agave, white peach, passion fruit, custard apple, banana or a combination thereof. A suitable plant-derived flavor enhancer source can provide flavor enhancement to the plant-only composition. An example of the plant-derived flavor enhancer is kithul, which can be obtained or extracted as a sap from the Caryota urens species of flowering plant in the palm family.

In some embodiments, the plant-derived nutrient enhancer comprises at least one of blueberries, strawberries, raspberries, cranberries, bilberry, redcurrant, blackberries, grapefruit, lingonberry, elderberry or a combination thereof.

In some embodiments, each plant-derived ingredient can be provided in a suitable amount to provide dairy replacement functionality in a particular type of food product. For example, the plant-derived cream (e.g., coconut cream) can be provided in an amount from about 5% or less to about 40% or greater (e.g., from about 5% to about 30%) by total weight of the plant-only composition/dairy replacement composition, one or more seed mucilage (e.g., flax seed mucilage and/or basil seed mucilage) can be provided in an amount from about 0.5% or less to about 10% or greater (e.g., from about 0.5% to about 7%) by total weight of the plant-only composition/dairy replacement composition.

In some embodiments, one or more of a vegetable mucilage and/or fruit mucilage (e.g., okra mucilage and/or mangosteen mucilage) can be provided in an amount from about 0.5% or less to about 10% or greater (e.g., from about 0.5% to about 7%) by total weight of the plant-only composition/dairy replacement composition, the plant-derived protein (e.g., pea protein or legume protein) can be provided in an amount from about 2% or less to about 20% or greater (e.g., from about 3% to about 18%) by total weight of the plant-only composition/dairy replacement composition, the plant-derived milk (e.g., seed milk such as hemp seed milk) can be provided in an amount from about 15% or less to about 60% or greater (e.g., from about 20% to about 55%) by total weight of the plant-only composition/dairy replacement composition.

In some embodiments, the plant-derived lactone enhancer source (e.g., peach or carrot) can be provided in an amount from about 0.1% or less to about 10% or greater (e.g., from about 0.3% to about 7%) by total weight of the plant-only composition/dairy replacement composition, the plant-derived flavor enhancer source (e.g., kithul) can be provided in an amount from about 0.1% or less to about 10% or greater (e.g., from about 0.3% to about 7%) by total weight of the plant-only composition/dairy replacement composition, and the plant-derived nutrient enhancer (e.g., berries) can be provided in an amount from about 0.5% or less to about 10% or greater (e.g., from about 1% to about 7%) by total weight of the plant-only composition/dairy replacement composition.

In the Table 1 provided below, an example embodiment of the plant-only composition/dairy replacement composition includes the following ingredients 102 in the amounts as indicated (weight percent based upon total weight of the composition):

TABLE 1
Plant-only dairy replacement composition:

| | Amount in |
|---|---|
| | plant-only |
| | composition |
| Plant-derived ingredients of the | (weight |
| plant-only composition | percentage %) |
| Plant-derived cream, Nuts & Tree nuts | 7-25 |
| (e.g., coconut cream) | |
| Plant-seed mucilage (e.g., flax seed | 1-5 |
| mucilage and/or basil seed mucilage) | |
| Fruit and/or vegetable mucilage (e.g., | 1-5 |
| okra mucilage) | |
| Plant-derived protein, legume, seed | 5-15 |
| (e.g., pea protein) | |
| Plant-derived milk (e.g., hemp seed milk) | 25-50 |
| Plant-derived lactone enhancer (e.g., peach | 0.5-5 |
| fruit or carrot vegetable) | |
| Plant-derived flavor enhancer (e.g., kithul) | 0.5-5 |
| Plant-derived nutrient enhancer, | 2-5 |
| Vitamins & minerals (e.g., berries such | |
| as blueberries, strawberries, etc.) | |

In some embodiments, the plant-only composition can be provided in a food product, e.g., in a frozen dessert product (e.g., ice cream), a milk product or other dairy product in an amount of about 1% to about 20% weight by weight of the food product, such as from about 2% to about 17% weight by weight of the food product, or from about 5% to about 15% weight by weight of the food product. In some embodiments, the dairy ingredient comprises any of milk, milk cream, butter, fermented milk product, yogurt, cheese, custard, frozen, or casein.

Table 2 provides physicochemical properties and ayurvedic properties of the various ingredients 102 used to form the plant-only composition/dairy replacement composition. It is to be noted that any combination (some or all) of the ingredients 102 can be combined to form the plant-only composition/dairy replacement composition.

TABLE 2
Ingredients in an example plant-only composition and their properties:

| | Milk or | Compounds | Effect on the | |
|---|---|---|---|---|
| | Egg | responsible for | properties | Ayurvedic |
| Ingredients | substitute | functionality | of ice cream | properties |
| Coconut | Substitute | Coconut cream has | Viscosity: | Rasa: |
| cream | to | a high lipid content | The viscosity | Madhur |
| (Plant- | milk fats | due to the presence | of the ice | (Sweet) |
| derived | | of medium chain | cream | Guna: |
| cream, | | fatty acids such as | increases due | Hima/ |
| Tree | | lauric, linoleic and | to the fats | Sheeta |
| Nuts) | | oleic acids. The | present. | (Cold) |
| | | fatty acids present | Overrun: | Snigdha |
| | | are saturated fat | Addition of | (Oily) |
| | | where 70% of the | coconut | Virya: |
| | | total fatty acid is | milk | Hima/ |
| | | lauric acid. The | increases | Sheeta |
| | | proteins present | viscosity. | (Cold) |
| | | had essential | Inclusion of | Vipaka: |
| | | amino acids. | coconut | Madhura |
| | | | products | (Sweet) |
| | | | resulted in | |
| | | | increased | |
| | | | total | |
| | | | phenolics | |
| | | | and minerals | |
| | | | (ash) and | |
| | | | decreased | |
| | | | overrun. | |
| | | | Meltdown | |
| | | | resistance: | |
| | | | the saturated | |
| | | | fatty acids | |
| | | | contribute to | |
| | | | the higher | |
| | | | melting | |
| | | | rates | |
| Flax seed | Egg | Mucilage of flax | Viscosity: | Rasa: |
| mucilage | replacer, | consists of two | Increased | Madhur |
| (Mucilage | Fat | polysaccharide | with the | (Sweet) |
| from | replacer, | components, | addition of | Tikta |
| Seeds) | Stabilizer | acidic and neutral, | flax seed | (Bitter) |
| | | at a ratio of 2:1. | mucilage | Guna: |
| | | The neutral | Overrun: | Guru |
| | | fraction contains | Addition of | (Heavy) |
| | | L-arabinose, D- | 0.025% | Snigdha |
| | | xylose and D- | mucilage | (Smooth) |
| | | galactose. The | improved | Virya: |
| | | acidic fraction | the overrun | Ushna |
| | | contains L- | of ice | (Hot) |
| | | rhamnose, L- | cream. | Vipaka: |
| | | fructose, L- | Melting | Katu |
| | | galactose and D- | rate: | (Pungent) |
| | | galacturonic acid. | Flaxseed | |
| | | Functionally, | mucilage | |
| | | polysaccharides | lowered the | |
| | | possess similar | melting rate | |
| | | properties to guar | of ice | |
| | | gum. | cream. Showed | |
| | | Lignans, | minimal fat | |
| | | Isoflavones, ALA | flocculation, | |
| | | (ω-3 fatty acid), | less | |
| | | dietary fibers, | stabilization | |
| | | high quality | of air cells | |
| | | protein with high | and high | |
| | | water binding | meltdown | |
| | | capacity, 1600- | rate. | |
| | | 3000 g of water/ | | |
| | | 100 g of solids. | | |
| | | High water | | |
| | | binding capacity | | |
| | | of flaxseed is | | |
| | | attributed due to | | |
| | | the presence of | | |
| | | polysaccharides | | |
| | | in the seed coat. | | |
| Okra | Egg | Polysaccharide- | Melting | Rasa: |
| mucilage | replacer, | rich material | resistance: | Madhura |
| (Mucilage | fat | containing | Increasing | (Sweet), |
| from | replacer, | galactose, | amounts of | Kashaya |
| Vegetable) | bulking | rhamnose and | okra | Guna: |
| | agent, | galacturonic acid | mucilage | Guru |
| | thickener, | at concentrations | increased | (heavy) |
| | stabilizer | between 20% and | the melting | Snigdha |
| | | 30%, also | rate in ice | (oily), |
| | | containing 11% of | cream | Picchila |
| | | protein, 40% of | Overrun: | (sticky) |
| | | carbohydrates, 10 | Increasing | Virya: |
| | | % of moisture, 10 | amounts of | Sheeta |
| | | % of ash, 0.5% of | okra | (cold) |
| | | magnesium, close | mucilage | Vipaka: |
| | | to 3.0% of | reduced the | Madhura |
| | | calcium, in | overrun in | (sweet) |
| | | addition to | ice cream | |
| | | potassium (0.1- | Viscosity: | |
| | | 0.7%) and | Addition of | |
| | | phosphorus (0.14- | okra | |
| | | 0.18%). | mucilage | |
| | | Okra mucilage | increases the | |
| | | can be extracted | viscosity of | |
| | | by several | ice cream | |
| | | methods, which | | |
| | | can directly | | |
| | | influence its | | |
| | | physicochemical | | |
| | | characteristics and | | |
| | | biological activity | | |
| Mango- | Egg | Neutral | High | Rasa: |
| steen | replacer, | arabinoxylans and | moisture | Madhura |
| (Mucilage | Emul- | acidic pectin-like | content, | (Sweet), |
| from fruit) | sifier, | rhamnogalacturon | water | Amla |
| | Stabilize, | an are the key | activity, | (Sour) |
| | also | polysaccharides | total | Guna: |
| | nutrient | that are present in | dissolved | Ruksha |
| | enhancer | the fruit mucilage. | solids, and | (dryness) |
| | | Active | crude fiber, | Guru |
| | | components of | suggesting | (Heavy) |
| | | mangosteen are | that | Virya: |
| | | xanthones (strong | mucilage | Ushna |
| | | antioxidants, the | addition | (Hot) |
| | | most significant | improves | Vipaka: |
| | | xanthone found in | various | Amla |
| | | mangosteen is a- | organoleptic | (Sour) |
| | | mangostin) and | and | |
| | | vitamins | chemical | |
| | | | characteristics. | |
| Pea | Substitute | Pea protein is | Viscosity: | Rasa: |
| Protein | for milk | mainly composed | Addition of | Madhura |
| (Plant- | protein, | of 7S/11S | pea protein | (Sweet), |
| derived | bulking | globulin (salt- | improved | Tikta |
| protein, | agent, | soluble, 65% to | the viscosity | (Bitter) |
| legume) | thickener | 80% of total) and | of ice | Guna: |
| | | albumin 2S (water | cream. | Hima, |
| | | soluble, 10% to | Overrun: | Tikta |
| | | 20%) protein | Addition of | Virya: |
| | | classes | pea protein | Hima/ |
| | | | was | Sheeta |
| | | | negatively | (Cold) |
| | | | correlated to | Vipaka: |
| | | | the overrun | Madhura |
| | | | Melting | |
| | | | time: | |
| | | | Addition of | |
| | | | pea protein | |
| | | | isolate led to | |
| | | | a rise in | |
| | | | resistance to | |
| | | | melting due | |
| | | | to high | |
| | | | viscosity. | |
| Hemp | Substitute | Hemp seed | Viscosity— | Rasa: |
| seed | for Milk, | milk is | amount of | Tikta |
| milk, | anti- | a high quality | hemp seed | (Bitter) |
| (Plant- | oxidant | protein source | milk | Guna: |
| derived | | containing all | increased | Laghu |
| milk) | | essential amino | in the | (light), |
| | | acids. Hemp seed | treatments | Teekshna |
| | | milk can serve to | the viscosity | (strong) |
| | | be potential | increased | Virya: |
| | | replacement as it | likely due to | Ushna |
| | | is natural | the effect of | (hot) |
| | | emulsions of | protein in | Vipaka: |
| | | polyunsaturated | the milk | Katu |
| | | fatty acids, | affecting the | (under- |
| | | essential fatty | absorption | goes |
| | | acids and other | of water in | pungent |
| | | fat-soluble | the | taste after |
| | | bioactive | formulation | digestion) |
| | | compounds. It | there by | |
| | | also consists of | increasing | |
| | | health benefits | the | |
| | | due to less | viscosity. | |
| | | saturated fats, less | Overrun— | |
| | | allergenicity. | As the | |
| | | However, the milk | viscosity | |
| | | needs a | increases | |
| | | stabilization | overrun | |
| | | system to achieve | increases | |
| | | the desired ice | thereby | |
| | | cream | improving | |
| | | characteristics. | the overrun | |

The plant-only composition/dairy replacement composition can be formed by combining and mixing the ingredients in any suitable manner, any suitable order and any suitable combination(s) so as to obtain a uniform, homogenous mixture. The plant-only composition can also be combined and mixed with any other food ingredients to form a food product (e.g., plant-only food product) in which the plant-only composition functions as a dairy substitute for the food product.

Table 3 provides parameter ranges and the functionalities associated with each plant-derived ingredient 102 of the plant-only composition/dairy replacement composition:

TABLE 3
Parameter ranges and the functionalities associated
with each plant-derived ingredient 102:

| Function- | | | | |
|---|---|---|---|---|
| ality of | | | | |
| plant-derived | | | | |
| ingredients | Parameters and ranges | | | |
| Plant- | Fat | pH: | Emulsion | |
| derived | percentage: | 3-6 | stability | |
| cream | 16-50% | | 50-96% | |
| Plant seed | Viscosity | Water holding | Foaming | Oil |
| mucilage | 6000 to | capacity | capacity: | Absorption |
| | 7500 | (WHC) 35 | More | Capacity: |
| | mPas | to 1024.66 | than 30% | More than |
| | | (g/g) | | 5% |
| Vegetable/ | Emulsion | Calories: | Oil | pH: |
| fruit | stability: | Low | Absorption | More than 3 |
| mucilage | 42.22 to | | capacity: | |
| | 70% or | | More than 5% | |
| | more. | | | |
| Plant- | Zeta | Solubility | High | Foaming |
| derived | potential | index | Solubility at | capacity: |
| protein | −20 to | 20-16% | pH below 4 | 38-120% or |
| (Emulsion | −40 mV | and | and above | more |
| ability | | Molecular | 5. Low | |
| depends | | weight: | solubility at | |
| on pH, | | 10-50 kDa | isoelectric | |
| elaborated | | | point | |
| below) | | | pH 4 to 5 | |
| Plant- | Presence of | Solubility: | Coliform-not | Bacterial |
| derived | 9 essential | pH | exceed 10 per | limits- not |
| milk | amino | dependant | ml. | greater than |
| (other | acids with | (minimum | | 20,000 |
| parameters | respect to | at | | per ml. |
| like | Bovine | isoelectric | | However, |
| proximate, | milk | point | | these |
| amino acid | | of proteins | | limits |
| profile and | | present) | | shall not |
| omega 3 | | | | apply to |
| & 6 are | | | | cultured |
| mentioned | | | | products. |
| below) | | | | |
| Lactones | Olfactive | Volatility | | |
| enhancer | impression | threshold | | |
| source | Floral/ | temperature | | |
| | creamy/ | Lactones from | | |
| | green/ | peach & | | |
| | milky. | strawberry | | |
| | | degrade at | | |
| | | thermal | | |
| | | treatment of | | |
| | | 70° C. for | | |
| | | 15 minutes. | | |
| Flavor | Olfactive | | | |
| enhancer | impression | | | |
| | Floral/ | | | |
| | creamy/ | | | |
| | green/milky | | | |
| Nutrient | Solubility | Bovine milk | The standards | |
| enhancer, | Should be | Vitamins & | can be checked | |
| Vitamins & | water | Minerals can be | with USDA | |
| minerals | soluble. | referred to: | (BFPD | |
| | | (calcium, | database): | |
| | | Riboflavin, | These have set | |
| | | phosphorus, | limits for | |
| | | vitamins A and | vitamins and | |
| | | B12, | minerals in | |
| | | potassium, | non-dairy | |
| | | magnesium, | based milk. | |
| | | zinc, iodine. | | |

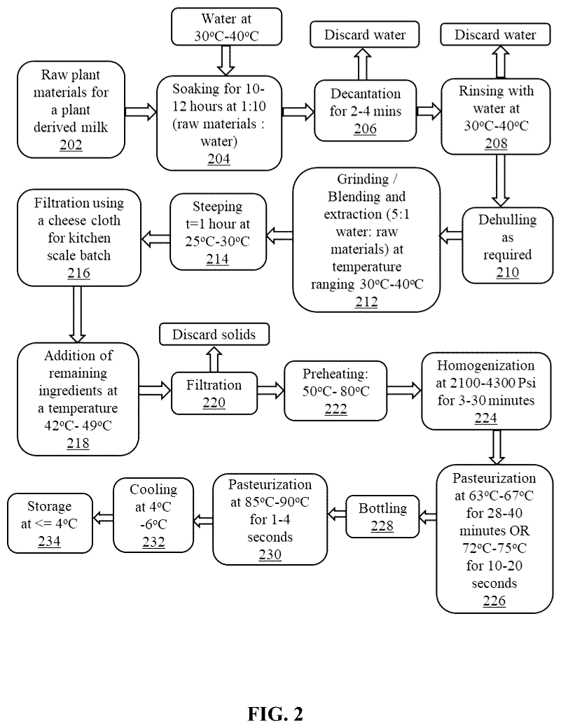

FIG. 2 illustrates a process of preparing a plant-only composition for a food product according to some embodiments herein. At a step 202, the raw materials for a plant-derived milk are taken. At a step 204, the raw materials for the plant-derived milk are soaked in water having a temperature ranging from 30° C. to 40° C. for 10-12 hours at a ratio of 1:10. At a step 206, the soaked raw materials are decanted for 2-4 minutes for removing water. At a step 208, the decanted raw materials are rinsed with water having a temperature ranging from 30° C. to 40° C. and then water is removed after rinsing. At a step 210, the rinsed raw materials are dehulled as required. At a step 212, the dehulled raw materials are grinded/blended with water in a ratio of 5:1 at a temperature ranging from 30° C. to 40° C. for extracting the plant-derived milk. At a step 214, the plant-derived milk is steeped for one hour at a temperature ranging from 25° C. to 30° C. At a step 216, the plant-derived milk is then filtered using a cheese cloth before adding the plant-derived milk to a plant-derived cream, a plant seed mucilage, a fruit and/or vegetable mucilage, a plant-derived protein, a plant-derived lactone enhancer, a plant-derived flavor enhancer, and a plant-derived nutrient enhancer. At a step 218, the plant-derived cream, the plant seed mucilage, the fruit and/or vegetable mucilage, the plant-derived protein, the plant-derived lactone enhancer, the plant-derived flavor enhancer, and the plant-derived nutrient enhancer is added to the plant-derived milk at a temperature ranging from 42° C. to 49° C. to obtain a plant-only composition.

At a step 220, filtering the plant-only composition for discarding solids. At a step 222, preheating the plant-only composition at a temperature ranging from 50° C. to 80° C. At a step 224, homogenizing the plant-only composition at 2100 Psi to 4300 Psi for 3-30 minutes. At a step 226, pasteurizing the plant-only composition at a temperature ranging from 63° C. to 67° C. for 28 to 40 minutes or 72° C. to 75° C. for 10 to 20 seconds. At a step 228, bottling the plant-only composition, followed by pasteurizing the bottled plant-only composition at a temperature ranging from 85° C. to 90° C. for 1 to 4 seconds at a step 230. At a step 232, cooling the plant-only composition at a temperature ranging from 4° C. to 6° C. At a step 234, storing the plant-only composition at a temperature less than 4° C.

### Ingredient Preparation Method:

Plant-derived cream: It is made by mixing the shredded coconut with water, homogenize. Further, filtering out the water layer and retaining the creamy layer. To make it to desired consistency/viscosity use a suitable stabilizer as per the application.

Plant seed/husk mucilage: Seeds/husk are boiled with water in a specific ratio (1-15. 1:20, 1:25) for a specific time range depending upon the use. Later, the mucilage part is filtered out and kept ready for use.

Fruit and/or vegetable mucilage: For example, for okra mucilage preparation, about 100 g of sliced and dried okra was dissolved in 3000 ml distilled water. It is heated in a water bath with continuous stirring for 1 hr at 60 C. The concentrated solution is filtered through a muslin cloth and cooled to room temperature. The filtered mucilage is dried in an oven at 45C. The hard mucilage cake is ground into a fine powder and passed through a sieve.

Plant-derived protein: The plant-derived protein can be obtained from different legumes as per the availability. The protein isolation and concentration is being done by solubilization and precipitation/filtration it to separate from carbohydrate part. The process of isolation should be clean label i.e. with minimum or no use of chemicals. The isolated proteins have good functionality.

Plant-derived milk: Plant-derived milk is prepared by (i) soaking raw plant materials for a plant-derived milk in water having a temperature ranging from 30° C. to 40° C. for 10-12 hours at a ratio of 1:10; (ii) decanting the soaked raw materials for 2-4 minutes for removing water; (iii) rinsing the decanted raw materials with water having a temperature ranging from 30° C. to 40° C.; and (iv) grinding/blending the rinsed raw materials with water in a ratio of 5:1 at a temperature ranging from 30° C. to 40° C. for extracting the plant-derived milk.

Plant-derived lactone enhancer, plant-derived nutrient enhancer and plant-derived flavor enhancer: Fruit, berry and vegetable pulps as lactone, flavor and nutrient enhancer-Fresh fruit, berries or vegetable is cleaned, peeled, deseeded, filtered and/or homogenized to desired consistency with or without addition of water.

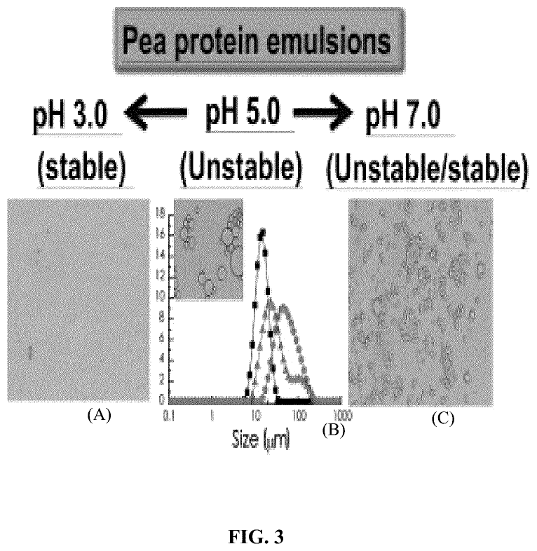

FIG. 3 illustrates an exemplary illustration of the emulsion stability of a plant-derived protein at various pH according to some embodiments herein. The emulsion of the plant-derived protein is pH dependent. The exemplary illustration of FIG. 3(A) shows that pea protein is stable at pH 3.0. The exemplary illustration of FIG. 3(B) shows that pea protein is unstable at pH 5.0. The exemplary illustration of FIG. 3(C) shows that pea protein is unstable/stable at pH 7.0. The exemplary illustration of FIG. 3 shows that pea protein has the best emulsifying ability below pH 4 and above pH 5.0 (other than its isoelectric point).

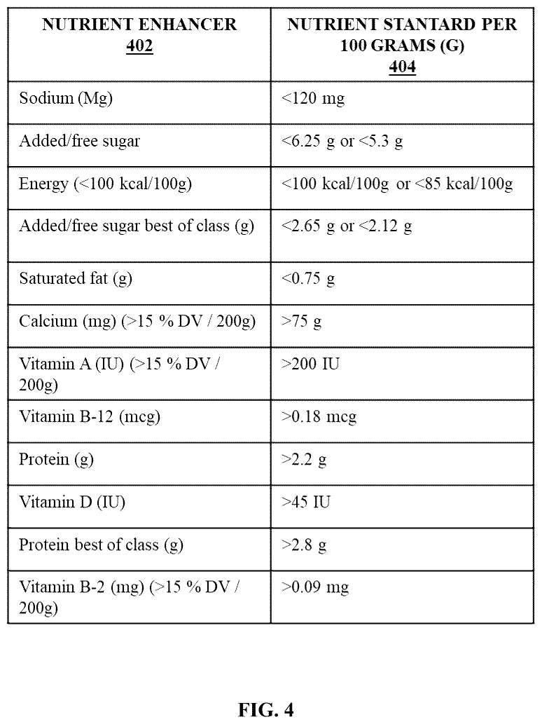

FIG. 4 illustrates an energy and minimum nutrient criteria of a plant-derived nutrient enhancer 402 for a plant-only composition applied according to some embodiments herein. FIG. 4 includes nutrient enhancer 402 and nutrient standard per 100 grams (g) 404. The plant-derived nutrient enhancer 402 includes sodium (<120 mg), added/free sugar (<6.25 g or <5.3 g), energy (<100 kcal/100 g), added/free sugar best of class (<2.65 g or <2.12 g), saturated fat (<0.75 g), calcium (>75 g), vitamin A-IU (>200 IU), vitamin B-12 (>0.18 mcg), protein (>2.2 g), vitamin D (>45 IU), protein best of class (>2.8 g), vitamin B-2 (>0.09 mg). The specific percentage of ingredients as shown in FIG. 4. The plant-derived nutrient enhancer 403 has set limits for vitamins and minerals in non-dairy based milks,

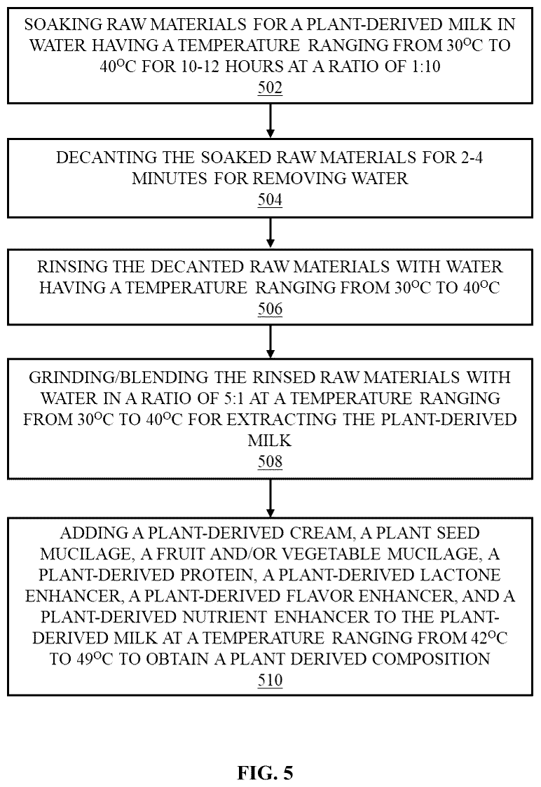

FIG. 5 illustrates a flow diagram of a process of preparing a plant-only composition for a food product according to some embodiments herein. At a step 502, raw materials for a plant-derived milk are soaked in water having a temperature ranging from 30° C. to 40° C. for 10-12 hours at a ratio of 1:10. At a step 504, the soaked raw materials are decanted for 2-4 minutes for removing water. At a step 506, the decanted raw materials are rinsed with water having a temperature ranging from 30° C. to 40° C. At a step 508, the rinsed raw materials are grinded/blended with water in a ratio of 5:1 at a temperature ranging from 30° C. to 40° C. for extracting the plant-derived milk. At a step 510, a plant-derived cream, a plant seed mucilage, a fruit and/or vegetable mucilage, a plant-derived protein, a plant-derived lactone enhancer, a plant-derived flavor enhancer, and a plant-derived nutrient enhancer is added to the plant-derived milk at a temperature ranging from 42° C. to 49° C. to obtain a plant-only composition.

In some embodiments, the process comprises steeping the plant-derived milk for one hour at a temperature ranging from 25° C. to 30° C., and filtering the plant-derived milk using a cheese cloth before adding the plant-derived milk to the plant-derived cream, the plant seed mucilage, the fruit and/or vegetable mucilage, the plant-derived protein, the plant-derived lactone enhancer, the plant-derived flavor enhancer, and the plant-derived nutrient enhancer.

In some embodiments, the process comprises (i) filtering the plant-only composition for discarding solids; (ii) preheating the plant-only composition at a temperature ranging from 50° C. to 80° C.; (iii) homogenizing the plant-only composition at 2100 Psi to 4300 Psi for 3-30 minutes; and (iv) pasteurizing the plant-only composition at a temperature ranging from 63° C. to 67° C. for 28 to 40 minutes or 72° C. to 75° C. for 10 to 20 seconds.

In some embodiments, the process comprises (i) bottling the plant-only composition, followed by pasteurizing the bottled plant-only composition at a temperature ranging from 85° C. to 90° C. for 1 to 4 seconds; and (ii) cooling the plant-only composition at a temperature ranging from 4° C. to 6° C. and storing it at a temperature less than 4° C.

While specific embodiments of the present disclosure have been shown and described in detail to illustrate the inventive principles, it will be understood that the present disclosure may be embodied otherwise without departing from such principles.

While considerable emphasis has been placed herein on the specific features of the preferred embodiment, it will be appreciated that many additional features can be added and that many changes can be made in the preferred embodiment without departing from the principles of the present disclosure. These and other changes in the preferred embodiment of the present disclosure will be apparent to those skilled in the art from the present disclosure herein, whereby it is to be distinctly understood that the foregoing descriptive matter is to be interpreted merely as illustrative of the present disclosure and not as a limitation.

The use of the expression “at least” or “at least one” suggests the use of one or more elements or components, as the use may be in the embodiment of the present disclosure to achieve one or more of the desired objects or results. While certain embodiments of the present disclosure have been described, these embodiments have been presented by way of example only, and are not intended to limit the scope of the present disclosure. Variations or modifications to the formulation of this present disclosure, within the scope of the present disclosure, may occur to those skilled in the art upon reviewing the present disclosure herein. Such variations or modifications are well within the spirit of this present disclosure.

Reference throughout this specification to “some embodiments”, “an embodiment”, or similar language means that a particular feature, structure, or characteristic described in connection with the embodiment is included in at least one embodiment of the present disclosure. Thus, appearances of the phrases “in some embodiments”, “in an embodiment” and similar language throughout this specification may, but do not necessarily, all refer to the same embodiment.

It should be understood that the figures shown above highlighting the functionality and advantages of the present disclosure are presented for example purposes only. The present disclosure is sufficiently flexible and configurable, such that it may be utilized in ways other than that shown in the figures.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A plant-only composition for a food product, comprising:
about 5% to 40% weight by weight of a plant-derived cream;
about 0.5% to 10% weight by weight of a plant seed mucilage;
about 0.5% to 10% weight by weight of a fruit and/or vegetable mucilage;
about 2% to 20% weight by weight of a plant-derived protein;
about 15% to 60% weight by weight of a plant-derived milk;
about 0.1% to 10% weight by weight of a plant-derived lactone enhancer;
about 0.1% to 10% weight by weight of a plant-derived flavor enhancer; and
about 0.5% to 10% weight by weight of a plant-derived nutrient enhancer, wherein the plant-only composition substitutes a diary ingredient in the food product.

2. The plant-only composition of claim 1, wherein the plant-derived cream comprises at least one of coconut cream, rice cream, cashew cream, sesame seeds cream, cassava cream, oat milk cream, white bean cream, tofu cream, three leaf yam cream, sweet potato cream, sunflower seeds cream or a combination thereof.

3. The plant-only composition of claim 1, wherein the plant-derived cream present in the plant-only composition ranges from about 5% to 30% weight by weight of the composition.

4. The plant-only composition of claim 1, wherein the plant-derived cream comprises a lipid percentage of about 16% to 50%, a pH of about 3 to 6, and an emulsion stability of about 50% to 96%.

5. The plant-only composition of claim 1, wherein the plant seed mucilage comprises at least one of flax seed mucilage, basil seed mucilage, chia seeds mucilage, psyllium seed mucilage, Balangu seed mucilage, quince seed mucilage, Arabidopsis seed coat mucilage, yellow mustard seed mucilage, sage seed mucilage, Ipomoea digitata seed mucilage, Eruca sativa seed mucilage or a combination thereof.

6. The plant-only composition of claim 1, wherein the plant seed mucilage present in the plant-only composition ranges from about 0.5% to 7% weight by weight of the composition.

7. The plant-only composition of claim 5, wherein the flax seed mucilage comprises a soluble fiber in an amount ranging from about 7% to 10% of the flax seed mucilage, neutral and acidic monosaccharides in an amount ranging from about 80% of the flax seed mucilage and protein in an amount ranging from about 9% of the flax seed mucilage.

8. The plant-only composition of claim 5, wherein the plant seed mucilage comprises a viscosity of about 6000 to 7500 millipascal (mPas), a water holding capacity (WHC) of about 35 to 1024.66 gram by gram and a foaming capacity of more than 30%.

9. The plant-only composition of claim 5, wherein the flax seed mucilage is synthesised by (i) stirring flax seeds for about 5 hours in distilled water at about 60° C. and at a mixing speed of about 300 revolution per minute (rpm) to obtain a flax seed solution, (ii) separating the mucilage from the flax seed solution by filtering through a 40-mesh screen, and (iii) precipitating the separated with 95% ethanol, followed by further separation by centrifuging at 3000 rpm for about 10 minutes.

10. The plant-only composition of claim 1, wherein the fruit and/or vegetable mucilage comprises at least one of okra mucilage, mangosteen mucilage, moringa mucilage, assyrian plum mucilage, prickly pear mucilage, cassava mucilage, spinach leaves mucilage, Basella alba mucilage, Indian jujube fruit mucilage, coromandel ebony mucilage, orange fiber mucilage, tilkor fruit mucilage or a combination thereof.

11. The plant-only composition of claim 1, wherein the fruit and/or vegetable mucilage present in the plant-only composition ranges from about 0.5% to 7% weight by weight of the composition.

12. The plant-only composition of claim 10, wherein the okra mucilage comprises (i) a polysaccharide rich material comprising galactose, rhamnose and galacturonic acid at concentrations between 20% and 30%, (ii) 11% of protein, (iii) 40% of carbohydrates, (iv) 10% of moisture, (v) 10% of ash, (vi) 0.5% of magnesium, (vii) about 3.0% of calcium, (viii) 0.1%-0.7% of potassium and (ix) 0.14%-0.18% of phosphorus.

13. The plant-only composition of claim 10, wherein the fruit and/or vegetable mucilage has an emulsion stability of about 42.22% to 70%, and an oil absorption capacity of more than 5%.

14. The plant-only composition of claim 1, wherein the plant-derived protein comprises at least one of pea protein, soy protein, potato protein, chickpea protein, quinoa protein, black lentil protein, peanut protein, almond protein, chia seed protein, pinto bean protein, oat protein, melon seed protein or a combination thereof.

15. The plant-only composition of claim 1, wherein the plant-derived protein present in the plant-only composition ranges from about 3% to 18% weight by weight of the composition.

16. The plant-only composition of claim 1, wherein the plant-derived protein comprises a zeta potential of −20 to −40 millivolt (mV), a solubility index of about 16% to 20%, a molecular weight of about 10 to 50 kilodaltons (kDa), and an improved solubility in the pH ranges below 4 and above 5, which is outside their isoelectric pH usually between 4 to 5.

17. The plant-only composition of claim 14, wherein the pea protein comprises 7S and 11S globulin proteins and 2S albumin proteins that simulate dairy and egg protein.

18. The plant-only composition of claim 1, wherein the plant-derived milk comprises at least one of hemp seed milk, oat milk, soy milk, potato milk, almond milk, sesame milk, macadamia milk, hazelnut milk, lupin milk, coconut milk, cowpea milk or a combination thereof.

19. The plant-only composition of claim 1, wherein the plant-derived milk present in the plant-only composition ranges from about 20% to 55% weight by weight of the composition.

20. The plant-only composition of claim 18, wherein the hemp seed milk comprises high quality protein source that includes all essential amino acids.

21. The plant-only composition of claim 1, wherein the plant-derived lactone enhancer comprises at least one of peach, carrot, apricots, raspberries, strawberries, pineapple, plums, celery, coconut, orange, filberts, peanuts or a combination thereof.

22. The plant-only composition of claim 1, wherein the plant-derived lactone enhancer present in the plant-only composition ranges from about 0.3% to 7% weight by weight of the composition.

23. The plant-only composition of claim 1, wherein the plant-derived flavor enhancer comprises at least one of kithul, raisins, durian, pears, prunes, monk fruit, sapodilla, agave, white peach, passion fruit, custard apple, banana or a combination thereof.

24. The plant-only composition of claim 1, wherein the plant-derived flavor enhancer present in the plant-only composition ranges from about 0.3% to 7% weight by weight of the composition.

25. The plant-only composition of claim 1, wherein the plant-derived nutrient enhancer comprises at least one of blueberries, strawberries, raspberries, cranberries, bilberry, redcurrant, blackberries, grapefruit, lingonberry, elderberry or a combination thereof.

26. The plant-only composition of claim 1, wherein the plant-derived nutrient enhancer present in the plant-only composition ranges from about 1% to 7% weight by weight of the composition.

27. The plant-only composition of claim 1, wherein the plant seed mucilage or the fruit and/or vegetable mucilage comprises pectin, and wherein the pectin forms a cross-linked gel in water in the presence of calcium ions, wherein the cross-linked gel network or polysaccharide entanglement mimics physical and sensory characteristics of emulsified fats that simulate milk/diary fats.

28. The plant-only composition of claim 1, wherein the plant-only composition of the food product is in the form of a gel or liquid.

29. The plant-only composition of claim 1, wherein the food product comprises a dessert product, ice cream, a frozen dessert, bakery and baked product, confectionary product, or milk-based beverages.

30. The plant-only composition of claim 29, wherein the dessert product comprises any of ice cream, frozen custard, ice milk, frozen yogurt, sherbet, water ices, whipped creams or edible dipping sauces.

31. The plant-only composition of claim 1, wherein the plant-only composition comprises lipids, polysaccharides, proteins and chemical compounds that are similar to those present in dairy based and/or egg-based ingredient.

32. The plant-only composition of claim 1, wherein the dairy ingredient comprises any of milk, milk cream, butter, fermented milk product, yogurt, cheese, custard, frozen, or casein.

33. The plant-only composition of claim 1, wherein the plant-only composition comprises
about 7% to 25% weight by weight of a plant-derived cream;
about 1% to 5% weight by weight of a plant seed mucilage;
about 1% to 5% weight by weight of a fruit and/or vegetable mucilage;
about 5% to 15% weight by weight of a plant-derived protein;
about 25% to 50% weight by weight of a plant-derived milk;
about 0.5% to 5% weight by weight of a plant-derived lactone enhancer;
about 0.5% to 5% weight by weight of a plant-derived flavor enhancer; and
about 2% to 5% weight by weight of a plant-derived nutrient enhancer, wherein the plant-only composition substitutes a diary ingredient in the food product.

34. A food product comprising a plant-only composition, wherein the plant-only composition comprises
about 5% to 40% weight by weight of a plant-derived cream;
about 0.5% to 10% weight by weight of a plant seed mucilage;
about 0.5% to 10% weight by weight of a fruit and/or vegetable mucilage;
about 2% to 20% weight by weight of a plant-derived protein;
about 15% to 60% weight by weight of a plant-derived milk;
about 0.1% to 10% weight by weight of a plant-derived lactone enhancer;
about 0.1% to 10% weight by weight of a plant-derived flavor enhancer; and
about 0.5% to 10% weight by weight of a plant-derived nutrient enhancer, wherein the plant-only composition substitutes a diary ingredient in the food product.

35. The food product of claim 34, wherein the plant-only composition present in the food product ranges from about 1% to 20% weight by weight of the food product.

36. A dairy replacement composition for a food product comprising a plant-only composition, wherein said plant-only composition comprises:
about 5% to 40% weight by weight of a plant-derived cream;
about 0.5% to 10% weight by weight of a plant seed mucilage;
about 0.5% to 10% weight by weight of a fruit and/or vegetable mucilage;
about 2% to 20% weight by weight of a plant-derived protein;
about 15% to 60% weight by weight of a plant-derived milk;
about 0.1% to 10% weight by weight of a plant-derived lactone enhancer;
about 0.1% to 10% weight by weight of a plant-derived flavor enhancer; and
about 0.5% to 10% weight by weight of a plant-derived nutrient enhancer, wherein the plant-only composition substitutes a diary ingredient in the food product.

37. A process of preparing a plant-only composition for a food product, the process comprising:
soaking raw materials for a plant-derived milk in water having a temperature ranging from 30° C. to 40° C. for 10-12 hours at a ratio of 1:10;
decanting the soaked raw materials for 2-4 minutes for removing water;
rinsing the decanted raw materials with water having a temperature ranging from 30° C. to 40° C.;
grinding/blending the rinsed raw materials with water in a ratio of 5:1 at a temperature ranging from 30° C. to 40° C. for extracting the plant-derived milk; and
adding a plant-derived cream, a plant seed mucilage, a fruit and/or vegetable mucilage, a plant-derived protein, a plant-derived lactone enhancer, a plant-derived flavor enhancer, and a plant-derived nutrient enhancer to the plant-derived milk at a temperature ranging from 42° C. to 49° C. to obtain a plant-only composition.

38. The process as claimed in claim 37, wherein the process comprises steeping the plant-derived milk for one hour at a temperature ranging from 25° C. to 30° C., and filtering the plant-derived milk using a cheese cloth before adding the plant-derived milk to the plant-derived cream, the plant seed mucilage, the fruit and/or vegetable mucilage, the plant-derived protein, the plant-derived lactone enhancer, the plant-derived flavor enhancer, and the plant-derived nutrient enhancer.

39. The process as claimed in claim 37, wherein the process comprises filtering the plant-only composition for discarding solids;
preheating the plant-only composition at a temperature ranging from 50° C. to 80° C.;
homogenizing the plant-only composition at 2100 Psi to 4300 Psi for 3-30 minutes; and
pasteurizing the plant-only composition at a temperature ranging from 63° C. to 67° C. for 28 to 40 minutes or 72° C. to 75° C. for 10 to 20 seconds.

40. The process as claimed in claim 39, wherein the process comprises
bottling the plant-only composition, followed by pasteurizing the bottled plant-only composition at a temperature ranging from 85° C. to 90° C. for 1 to 4 seconds; and
cooling the plant-only composition at a temperature ranging from 4° C. to 6° C. and storing it at a temperature less than 4° C.
